(19) United States
(12) Patent Application Publication
(10) Pub. No.: US 2016/0182950 A1
(43) Pub. Date: Jun. 23, 2016

(54) IDENTIFICATION OF A USER FOR PERSONALIZED MEDIA CONTENT PRESENTATION

(71) Applicant: Lenovo (Singapore) Pte. Ltd., Singapore (SG)

(72) Inventors: Douglas Warren Robinson, Raleigh, NC (US); Aaron Michael Stewart, Raleigh, NC (US)

(21) Appl. No.: 14/573,743

(22) Filed: Dec. 17, 2014

(51) Int. Cl. H04N 21/45; H04N 21/462; H04N 21/4415; H04N 21/442; H04L 29/06; H04N 21/422

(52) U.S. Cl. CPC H04N 21/4532; H04L 65/60; H04N 21/42201; H04N 21/42222; H04N 21/4415; H04N 21/44218; H04N 21/462

(57) ABSTRACT

One embodiment provides a method, including: detecting, using a sensor, one or more user characteristics; identifying, using the one or more user characteristics, a user currently handling a remote control device; associating, using a processor, a media device setting with the user currently handling the remote control device; and implementing, using a processor, the media device setting. Other aspects are described and claimed.

### BACKGROUND

Media devices (e.g., personal computing devices, media streaming devices, cable set top boxes, satellite television receivers, smart televisions (TVs), digital video recorders (DVRs), game consoles, etc., referred to herein simply as “media devices”) allow a user to view media (e.g., movies, television shows, web content, etc.). Some media devices may be programmed by a user to create and store settings unique to a particular user. A user may personalize the media device in a variety of ways.

For example, a user may be able to create and store unique channel line-ups or other settings on media devices. Parental locks or codes, for example, may be implemented in order to restrict certain content, channels and the like. This personalization allows, by way of example, a particular user to create an individual user guide on a TV set top box that is displayed for the user. The media device may also allow multiple individuals to have their own accounts or unique settings stored on the same media device. An individual may then access their own settings, e.g., by traversing multiple menus. Often this requires entry of a password or code (e.g., parental lock code) for user authentication or identification.

### BRIEF SUMMARY

In summary, one aspect provides a method, comprising: detecting, using a sensor, one or more user characteristics; identifying, using the one or more user characteristics, a user currently handling a remote control device; associating, using a processor, a media device setting with the user currently handling the remote control device; and implementing, using a processor, the media device setting.

Another aspect provides a remote control device, comprising: a processor; at least one sensor operatively coupled to the processor, wherein the at least one sensor detects one or more user characteristics; and a communication device operatively coupled to the processor; wherein the processor identifies, using the one or more user characteristics, a user currently handling the remote control device.

A further aspect provides a system, comprising: one or more processors; at least one sensor operatively coupled to the one or more processors; and one or more memory devices that store instructions executable by the one or more processors to: detect one or more user characteristics; identify, using the one or more user characteristics, a user currently handling a remote control device; associate a media device setting with the user currently handling the remote control device; and implement the media device setting.

A further aspect provides a product, comprising: a storage device having code stored therewith, the code being executable by a processor and comprising: code that detects, using a sensor, one or more user characteristics; code that identifies, using the one or more user characteristics, a user currently handling a remote control device; code that associates a media device setting with the user currently handling the remote control device; and code that implements the media device setting.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an overview of an example system for identification of a user for personalized content.

FIG. 4 illustrates an example method of identification of a user for personalized content.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Information handling devices which provide media content to a user (herein “media devices”) may provide a user with many options for media consumption. For example, a standard program guide from a cable service provided by a set top box or satellite television receiver may include hundreds of television channels to choose from, a DVR device may store many hours of DVR recordings, etc. Generally, a user may be able to individualize their content experience on such media devices by creating and storing unique settings/profiles.

For example, a user may record and store television programs organized according to a personal account or listing, create user specific channel guides, create personalized music playlists, and the like. Additionally, a user may be able to set passwords in order to prevent others from accessing certain content. For example, a parent may set parental controls in order to prevent a child from accessing content which the parent deems inappropriate. After setting these passwords or creating these personalized accounts or other settings on the media device, however, the user conventionally must enter the correct password or pass code in order to access this content or at the very least must be identified or authenticated to retrieve his or her personalized settings, etc. Conventionally this is accomplished via manual input, e.g., key presses on a TV remote control, keyboard entry on a tablet or personal computer, and the like. Often this includes navigating proprietary menus defined by each media device. As most users have experienced, configuring the media device for a personalized experience can be a challenging task, and each time the user wishes to so configure the media device, pass codes and complex menu navigation encumber the user experience.

In order to assist a user in communicating with a media device, various remote control devices (e.g., standard TV remote control (infrared, radio frequency, etc.), so-called universal remote controls, tablet or smart phone applications, etc.) have been developed. These remote control devices may be used to control the media device wirelessly from a distance. However, generally the remote control devices simply act as a remote input device that allows a user to send signals to the media device, e.g., corresponding to user selections on the remote control device (channel up/down, volume increase/decrease, power control, etc). In some cases, these devices may include additional functionality, for example, keyboards, numeric key pads, proprietary applications with extended program guide information, and the like. While such technology may allow a user to communicate with the media device, even with these technological advances a user must make selections and navigate menus to access their individual content.

Accordingly, an embodiment provides a technological improvement to inter-device communication in the media context. By way of example, an embodiment provides a method of identifying a user by leveraging sensors integrated with or connected to a remote control device. This user identification data may include user authentication, and as such user identification or authentication data may be seamlessly provided to the media device in a user friendly manner. This relieves the user from tedious and often confusing manual inputs and menu navigation steps required to access custom settings on a media device. An embodiment permits a user to access his or her individual content and media playback settings without providing any additional input or navigating menus.

By way of example, simply by holding the remote control with a grip and orientation that the user is accustomed to doing, an embodiment may detect user identification data from sensors of the remote control, for example, biometric sensors, hand placement or grip sensors, and the like, and use that user identification information to identify a user to the media device in question. This identification may include comparing the received data to stored user data (e.g., in a user profile) to determine the particular user that is currently holding the remote control device. Upon identifying a user, an embodiment may send a signal containing identification or authentication information to the media device such that the media device may provide user-specific content, settings, etc., associated with the individual user that has been identified or authenticated. For example, if the user is a parent and the media device has parental controls enabled, the signal may include the parental control password allowing the user to access restricted content.

The illustrated example embodiments will be best understood by reference to the figures. The following description is intended only by way of example, and simply illustrates certain example embodiments.

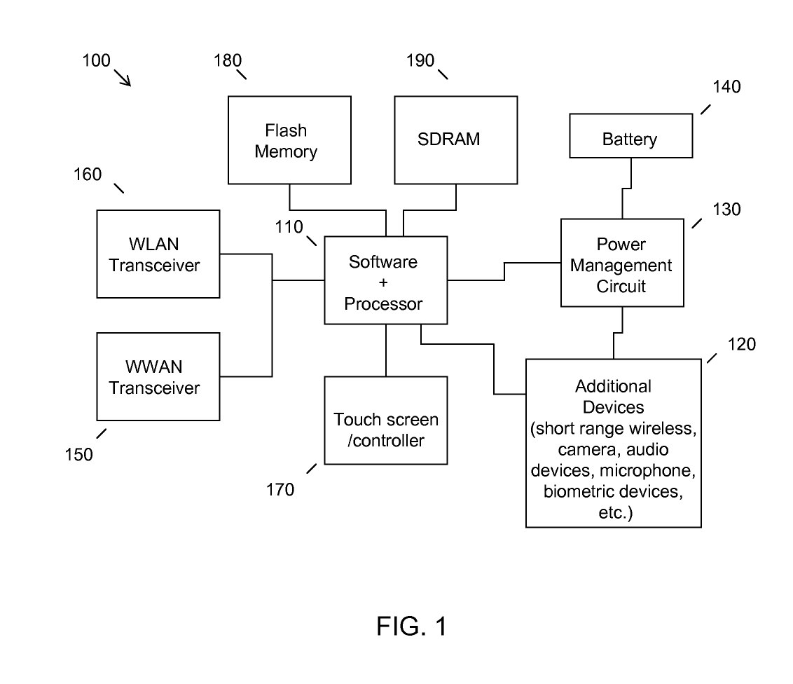

While various other circuits, circuitry or components may be utilized in information handling devices, with regard to smart phone and/or tablet circuitry 100, an example illustrated in FIG. 1 includes a system design found for example in tablet or other mobile computing platforms. Software and processor(s) are combined in a single circuit 110. Processors comprise internal arithmetic units, registers, cache memory, busses, I/O ports, etc., as is well known in the art. Internal busses and the like depend on different vendors, but essentially all the peripheral devices (120) may attach to a single circuit 110. System 100 also combines the processor, memory control, and I/O controller hub all into a single circuit 110. Systems 100 of this type do not typically use SATA or PCI or LPC. Common interfaces, for example, include SDIO and I2C.

There are power management circuit(s) 130, e.g., a battery management unit, BMU, which manage power as supplied, for example, via a rechargeable battery 140, which may be recharged by a connection to a power source (not shown). In at least one design, a single circuit 110 is also used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included, e.g., biometric input devices, for example, camera(s), audio devices, microphone(s), biometric devices (e.g., fingerprint scanner), and the like. System 100 often includes a touch screen 170 for data input and display/rendering. System 100 also typically includes various memory devices, for example flash memory 180 and SDRAM 190.

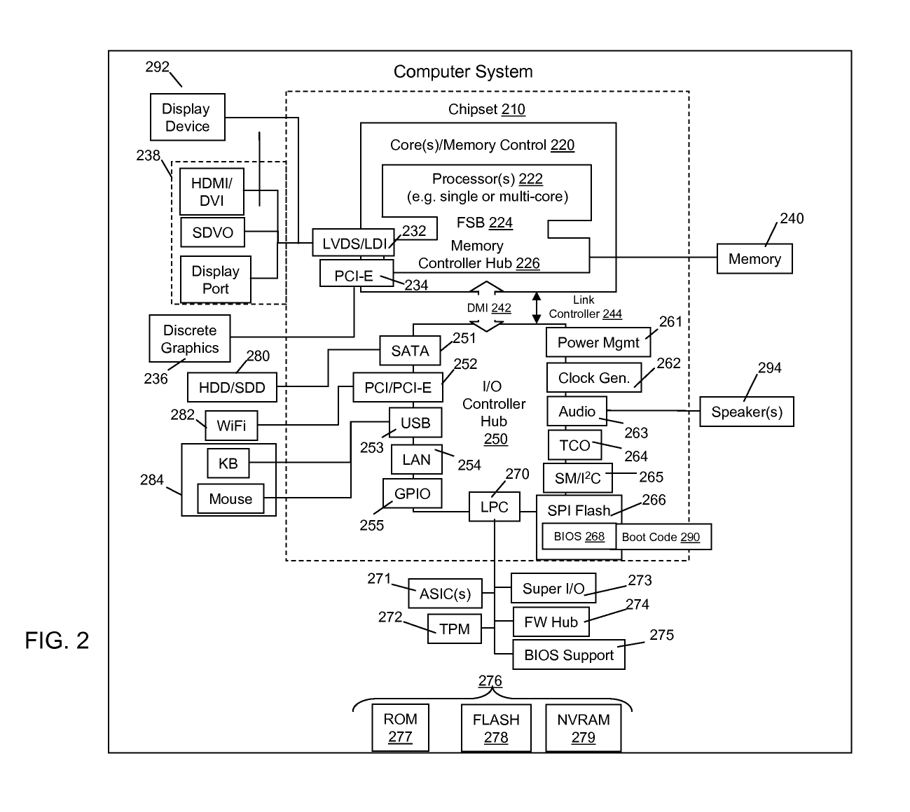

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, biometric input devices, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which users may use to consume media content. Alternatively or additionally, circuitry as outlined in FIG. 1 or FIG. 2 may be used in controller devices used to control media devices. For example, the circuitry outlined in FIG. 1 may be implemented in a tablet or smart phone embodiment, whereas the circuitry outlined in FIG. 2 may be implemented in a media device embodiment.

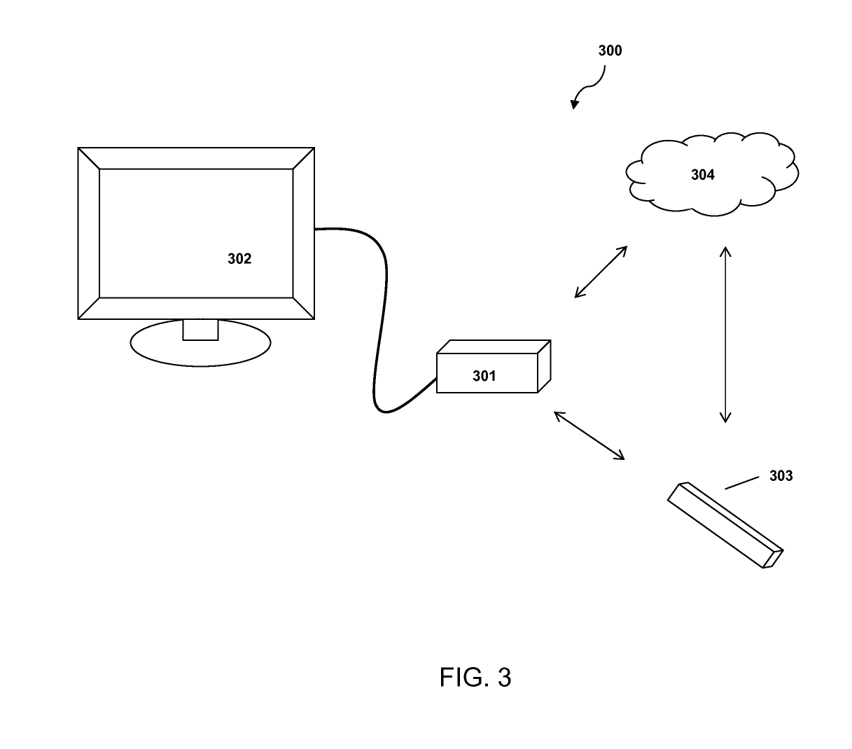

An embodiment operates in the context of personalized media consumption. By way of example, illustrated in FIG. 3 is an example system 300 for identification of a user for personalized content. As shown a media device 301, e.g., streaming media device, set top box, etc., is operatively connected to a display device 302, noting that media device 301 and display device 302 may be consolidated into a single device, e.g., smart TV.

A remote control device 303 may take the form of hand-held mobile device such as an IR remote television control, universal remote, smart phone or tablet computing device. This remote control device 303 operates to wirelessly communicate with the media device 301 and the display device 302. This communication may be direct, e.g., IR or other wirelessly transmitted signal directly communicated to one or more of the display device 302 and the media device 301. It should be noted that in some embodiments the remote control device 303 may include a wired connection with the media device 301 or another local device, e.g., display device 302, as for example in the context where the media device 301 is a gaming console and the remote control device 303 is a game controller.

The remote control device 303 may likewise communicate information and data to other system components such as the media device 301 and display device 302 via an intermediary device, e.g., cloud account device hosted in a cloud service 304. This may allow additional processing to be applied by a cloud service 304 and associated devices, e.g., where remote control device 303 simply acts to collect or sense data needed to identify the user but lacks sufficient processing power to locally process the data.

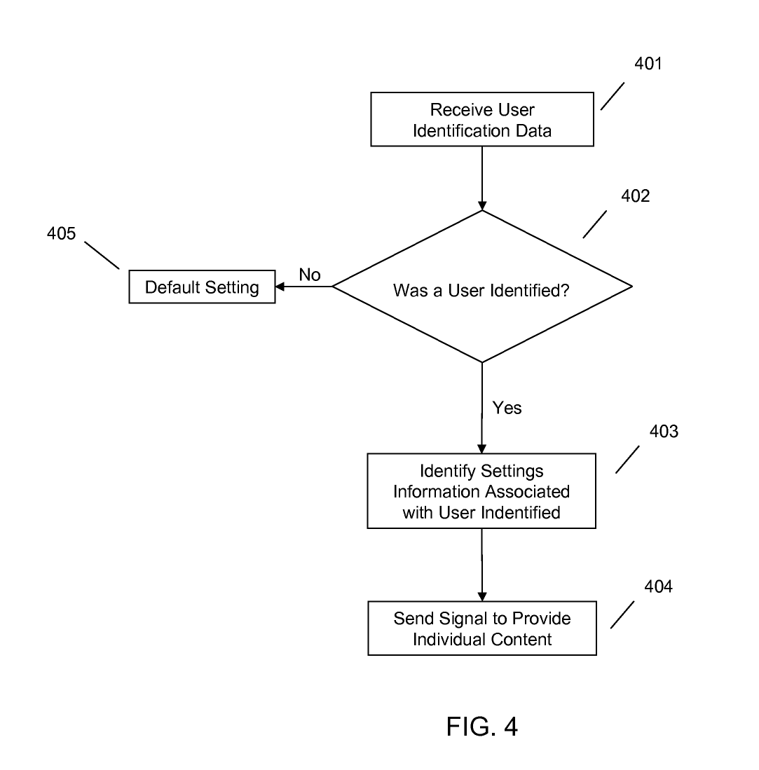

As will become more apparent from the following description in connection with FIG. 4, the remote control device 303 includes one or more sensors (not explicitly illustrated) that permit the detection of user identification information. The sensor(s) may take the form of contact or grip sensors (e.g., capacitive or mechanical sensors) that distinguish user holding styles. The sensors may include more complex sensing devices, e.g., biometric sensing devices such as a fingerprint reader, camera or the like.

Additionally it should be noted that, e.g., if media device 301 is a gaming console or like device, other devices may include sensor(s) that are used to identify the user handling the remote control device 303 or increase the confidence of this identification. By way of example, media device 301 may include a three dimensional camera or other system that is capable of detecting images of the user holding the remote control device 303 and identifying the user. The sensors may also include sensors that detect wireless communication protocols, for example, short range communications, near-field communications, and the like. For example, an embodiment may detect a short range wireless identification from an electronic device the user is currently holding. For example, the user's smart phone may provide a short range wireless identification of the user.

Referring now to the non-limiting example illustrated in FIG. 4, an embodiment may receive user identification data (e.g., one or more user characteristics) at a remote control device (e.g., TV remote control, smart phone, or other device used to control a media device) at 401. The user identification data may include a variety of data types that are used alone or in some combination to identify the user currently handling the remote control device. For example, an embodiment implemented using a smart phone as a remote control device may include a fingerprint reader that captures biometric data such as fingerprint data.

Other techniques may be used to identify a user, e.g., identifying a particular user or a user type (e.g., adult versus child user). For example, a user may be identified by detecting grip data, as for example sensed via touch or optical sensors provided with the remote control device. By way of example, optical sensors located on peripheral edges of the device may be used to ascertain vein pattern data of a particular user's grip. Similarly, grip placement data such as contact points on the remote control may be used to identify a user. This may be appropriate for example in distinguishing left and right handed users, users having differently sized hands or fingers, etc. Other grip or contact sensors may be used, for example pressure sensors (e.g., physically deformable or mechanical pressure sensors or capacitive sensors that infer grip pressure from contact area growth, etc.) may be used to identify a particular user based on grip location, grip pressure, etc. Still other sensors, such as a 9-axis sensor module, may provide device orientation information that permits an inference of which user (particular user or user type) is handling the remote control device (e.g., held by a left handed user rather than a right handed user, etc.).

Moreover, a device type or identification may be used to identify a user. For example, a first user device may be associated with a particular user whereas a second user device may be associated with another user. Thus, detection of the first user device, e.g., using a device ID such as a MAC address, may allow an embodiment to identify a user and produce an identification result, which in turn permits implementation of user-specific settings on a media device.

As another example, user login or like information used to access a remote control device, e.g., user login to a social media account on a smart phone used as a remote control device, may likewise be used to produce a user identification result. Thus, a user login to a device or device application may be leveraged to identify a particular user with the remote control device and thereafter implement personalized settings.

As will be readily appreciated, many modern personal electronics are equipped with microphones and cameras that may capture audio data, image data, and the like. Such data may prove useful in identifying a particular user or increasing the confidence score of a partial identification.

The user identification data therefore may be received at 301 by a sensor or a plurality of sensors connected to or located on or with the controller device or a device in proximity to the remote control device (e.g., media device 301, display device 302, etc). For example, an optical system such as used in many gaming systems may be wirelessly connected to the controller device or a cloud service, permitting access to auxiliary user identification data available in the home. In some embodiments, previously determined user identification, e.g., past login to a remote controller device such as a smart phone or a tablet, may be utilized as user identification data or used to adjust or change a previously identified user, as further described herein.

If a user is identified at 402, an embodiment may use the identification to associate the user's identity with settings information at 403. For example, a first user might be associated with a particular channel line up, parental control unlock permissions etc., whereas a second user may be associated with a second channel line up and without parental control unlock permissions. This may correspond to a scenario where the first user is a parent and the second user is a child.

In one embodiment, user identification data may have to be provided or detected/received, e.g., by the remote control or other device, for a predetermined length of time prior to any user identification result being produced. Additionally or in the alternative, other sensed data (e.g., remote control is moving above a predetermined threshold) may be used to cancel a user identification event. This length of time or other data may be configured by the user or may be included in default settings.

By way of example, a time requirement may prevent inadvertently identifying a new user (and implementing a settings change) based on a temporary device handling event. Therefore, if a new user picks up a remote control temporarily to move it to another location, it may be preferable that this not be detected as a change in user for settings purposes. Such a determination may be based on the short time duration of receipt of user biometric data (e.g., contact data with a remote control) or via other data (e.g., accelerometer data indicates the remote is being repositioned). Similarly, if one individual is passing a controller to another person, the controller, although it may capture user identification data associated with the passing individual, it may not act on this because the passing individual did not handle the controller for long enough or because of the way in which the remote control device is moving or oriented.

At 402 an embodiment may positively identify a user using the user identification data received at 401. For example, if an individual is handling a smart phone to control a media system such as a cable television set top box, a media streaming device such as a ROKU device, etc., the individual may be identified by the smart phone at 302, e.g., by virtue of simply handling the phone using a particular grip, etc.

This user identification data may be used to produce a user identification result that is associated with settings information at 403. For example, the user identification data may be used to produce an identification result, which is then leveraged to retrieve a stored user profile containing settings information. It is worth noting that this identification processing may take place on the remote control device, a secondary device (such as media device 301) that is connected to the remote control device, a cloud device (e.g., hosted in cloud service 304), etc. In other words, the remote control device may process the user identification data locally to produce an identification result, associated settings with the identified user, and transmit that settings information to the media device. Alternatively, a remote control device may simply pass through user identification data, e.g., hand contact location, etc., to another device for processing. Likewise, a controller device may produce an identification result which is then transmitted to the media device or an intermediary device to perform a user settings look up.

In one embodiment, a user may access a menu or options setting in order to provide data for a user profile. As an example, a user may access a setting or menu within the remote control device to provide user identification data (e.g., voice data, other biometric data such as device contact data, etc.). This may take the form of a training or initialization of the remote control device such that at a subsequent time it may faithfully identify the user. This data may be stored locally by the remote control device or this data may be stored remotely and thereafter used to compare received user identification data against.

In a training mode, the remote control device may allow a user to perform various actions or provide various data to the remote control device or other devices (e.g., such as illustrated in FIG. 3). For example, if a remote control device has sensors that allow detection of a user's hand and/or finger placement, a user may be required to pick up the remote control device and use it to operate a media device multiple times so that the remote control device or other system devices with sensors can learn how that particular user holds and operates the remote control device. As part of this process, a user may be asked to provide a special or secret grip or hand placement that may act as a pass code for uniquely identifying the particular user.

The remote control device or another system device may then associate the stored training data with a user profile for later use. The user profile(s) may include data in addition to comparison data. For example, the user profile(s) may include a name, username, password, other data that may be used to access personalized content on a media device, and the like.

In one embodiment, the identification of the user at 402 may include determining that the received user identification data matches one of the stored user profiles. A notification or indication that the user has been identified may be provided upon successful identification. This identification may include, for example, a light, pop-up display, sound, haptic notification, and the like. Alternatively, the identification of the user may include determining that the received user identification data does not match one of the stored user profiles. Upon an unsuccessful identification at 402, an embodiment may provide a notification or indication that the identification was unsuccessful and that standard or default settings control at 405.

Therefore, if an embodiment cannot identify the user at 402, the controller device may implement a default setting at 405. For example, the media device may perform as if the remote control device does not have the additional identification functionality. The remote control device may send a signal to the media device to display the default content setting or the last used content setting.

If a user is identified at 402, an embodiment may send a signal (directly or indirectly) to the media device at 404 indicating the same. This signal may contain information allowing the media device to look up the user's stored settings (e.g., stored on the media device or on a device operatively coupled to the media device). This signal may also contain the settings information itself, e.g., parental unlock code, or instructions for implementing settings, e.g., TV program guide menu selection(s) and the like. Alternatively, if a user is identified, an embodiment may implement a media device setting on the remote control device. For example, if the remote control device allows customization (e.g., each user is presented with a different display or icons on the display of the remote control device), an embodiment may implement the configuration which is customized to the user.

This permits the media device to be configured automatically according to a user's saved settings information. For example, the media device will automatically provide content associated with the identified user such as a particular list of recorded programs, user-specific bookmarks, playlists, user guides, etc.

The signal transmitted from the remote control device at 404 thus may include, for example, all information required by the particular media device to implement user specific settings. That is, the signal may contain a series of menu selections that are configured to automate the manual menu selection process for the user. This information is used by the media device to determine which personalized content to provide. For example, if a user has set up a personalized user guide, the signal information transmitted at 404 may include the data the media device requires to access that personalized user guide via menu selections. Again, this signal may be communicated directly to the media device or the signal may be communicated indirectly to the media device. In one embodiment, the signal is transmitted directly to the media device, which uses the signal as an instruction to coordinate with other devices (e.g., cloud service 304 devices) to retrieve remotely stored user settings, instructions sets, etc.

In an embodiment, code running on the media device may interpret the signal information sent at 404 for navigating the menus of the media device. For example, the code on the media device may include a script, macro, other set of instructions for navigating the native or proprietary menus of the media device. Therefore, if the user would normally have to navigate three menus and enter a pass code to access his or her individual content, the controller may send a signal to the media device initiating or even comprising the instructions for navigating the menus so that the user does not have to manually navigate the menus.

In additional or alternative embodiments, the steps associated with the remote control device above may be performed by other devices within the system. For example, in one embodiment, the remote control may detect one or more user characteristics (e.g., identification data), and communicate this information to the media device. The media device may then identify the user and associate and implement the user's media device setting. Alternatively, the remote control device may receive identification data, identify the user, and communicate this information to the media device for association and implementation of the media device setting. As an alternative example, the remote control device may receive identification data and communicate this data to a remote storage device (e.g., a cloud storage). The remote storage device may then identify the user and associate a media device setting with the user. The remote storage device may then communicate this information to the media device which may then implement the media device setting. As will be apparent to those skilled in the art, other combinations are possible.

Accordingly, as illustrated by the example embodiments and figures, an embodiment provides a method for providing personalized content to a user through identification of the user at a controller device. The identification may include receiving data from sensors connected to or located on the controller device. The received data may then be compared to stored user data to determine the particular user who is handling the controller device. The controller may then send a signal to the information handling device identifying the user and providing the information required to access the personalized content. Thus, an embodiment provides a method allowing a user to access personalized content without the user having to manually provide information or navigate menus.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, using a sensor, one or more user characteristics;
identifying, using the one or more user characteristics, a user currently handling a remote control device;
associating, using a processor, a media device setting with the user currently handling the remote control device; and
implementing, using a processor, the media device setting.

2. The method of claim 1, wherein the detecting comprises using a sensor of the remote control device to detect data indicating hand placement of the user.

3. The method of claim 1, wherein the one or more user characteristics comprises biometrics.

4. The method of claim 1, wherein the identifying comprises comparing the one or more user characteristics received to at least one stored user profile.

5. The method of claim 1, wherein the detecting comprises receiving the one or more user characteristics for a predetermined length of time.

6. The method of claim 1, further comprising providing an indication that the user has been identified.

7. The method of claim 1, wherein the media device setting includes a setting selected from the group consisting of: a personalized channel listing, a personalized recorded video listing, personalized media bookmarks, and personalized content access.

8. The method of claim 1, wherein the associating is performed at a location selected from the group consisting of: the remote control device, the media device, and a network connected device operatively coupled to the media device.

9. The method of claim 1, wherein the detecting comprises detecting a short range wireless identification signal.

10. A remote control device, comprising:
a processor;
at least one sensor operatively coupled to the processor, wherein the at least one sensor detects one or more user characteristics; and
a communication device operatively coupled to the processor;
wherein the processor identifies, using the one or more user characteristics, a user currently handling the remote control device.

11. The remote control device of claim 10, wherein the communication device communicates an indication of the user currently handling the remote control device to a media device.

12. The remote control of claim 10, wherein the sensor detects hand placement of the user.

13. The remote control of claim 10, wherein
the processor associates a media device setting with the user currently handling the remote control device; and
the communication device communicates the media device setting to the media device.

14. The remote control device of claim 10, where the processor uses the one or more user characteristics to customize the remote control device for the user currently handling the remote control device.

15. A system, comprising:
one or more processors;
at least one sensor operatively coupled to the one or more processors; and
one or more memory devices that store instructions executable by the one or more processors to:
detect one or more user characteristics;
identify, using the one or more user characteristics, a user currently handling a remote control device;
associate a media device setting with the user currently handling the remote control device; and
implement the media device setting.

16. The system of claim 15, wherein the at least one sensor comprises a short range wireless device, and wherein the one or more user characteristics comprise a short range wireless identification.

17. The system of claim 15, wherein the system comprises a remote control device; and
wherein the at least one sensor is disposed in the remote control device.

18. The system of claim 15, wherein the system comprises a media device; and
wherein a processor of the media device implements the media device setting.

19. The system of claim 15, wherein the system comprises a media device; and
wherein the at least one sensor is operatively coupled to the media device.

20. The system of claim 19, wherein the at least one sensor is a camera operatively coupled to the media device.

21. The system of claim 15, wherein the media device setting includes a setting selected from the group consisting of: a personalized channel listing, a personalized recorded video listing, personalized media bookmarks, and personalized content access.

22. The system of claim 15, further comprising a television and a media device, wherein the television is operatively coupled to the media device;
the television displaying media content from the media device according to the media device setting.

23. The system of claim 15, further comprising:
a media device;
a remote control device; and
a network connected device;
wherein associating the media device setting with the user currently handling the remote control device is performed at a location selected from the group consisting of:
the remote control device, the media device, and the network connected device.

24. The system of claim 15, wherein the one or more user characteristics comprises data indicating the hand placement of the user.

25. A product, comprising:
a storage device having code stored therewith, the code being executable by a processor and comprising:
code that detects, using a sensor, one or more user characteristics;
code that identifies, using the one or more user characteristics, a user currently handling a remote control device;
code that associates a media device setting with the user currently handling the remote control device; and
code that implements the media device setting.
